(19) United States
(12) Patent Application Publication
(10) Pub. No.: US 2010/0042612 A1
(43) Pub. Date: Feb. 18, 2010

(54) Method and system for ranking journaled internet content and preferences for use in marketing profiles

(76) Inventor: Ahmed A. Gomaa, Glen Ridge, NJ (US)

Correspondence Address: DARBY & DARBY P.C., P.O. BOX 770, Church Street Station, New York, NY, 10008-0770, US

(21) Appl. No.: 12/459,469

(22) Filed: Jun. 30, 2009

Related U.S. Application Data
(60) Provisional application No. 61/080,022, filed on Jul. 11, 2008.

(51) Int. Cl. G06F 17/30; G06F 15/173

(52) U.S. Cl. 707/5; 707/E17.108; 709/224

(57) ABSTRACT

A method and system for ranking and categorizing journaled internet data sources for use in marketing and advertising. Journaled internet data sources are identified and examined. Journal data is retrieved from one or more of the data sources and a voting algorithm is applied to classify the journaled data. The journaled data is associated with one or more content categories of a monitoring taxonomy that specifies content categories and relationships between the content categories. Based on the associations, an interest level, an interaction level, a direction level, or authority level is computed and used to rank the journaled data. The rankings are stored and can be provided for use in targeted marketing and advertising.

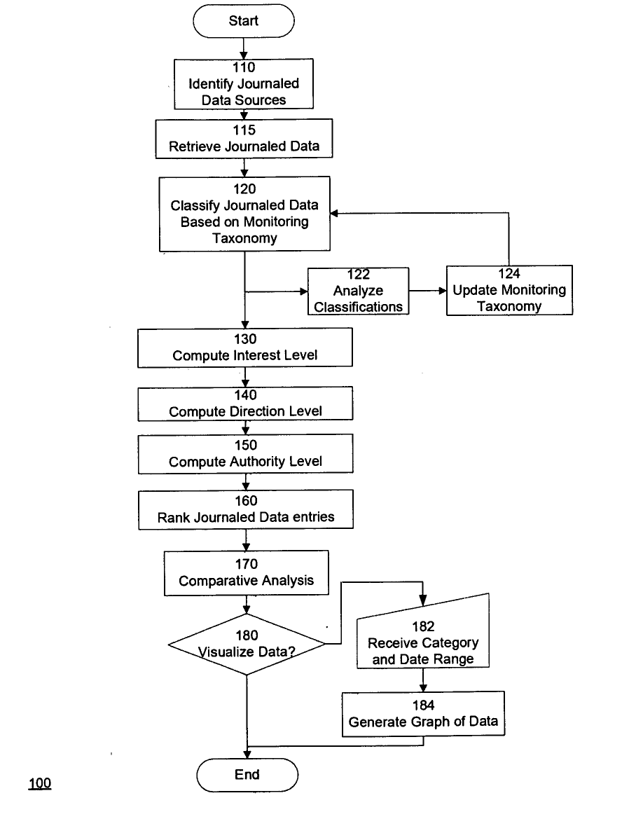

This application claims priority pursuant to 35 U.S.C. §119(e) to U.S. Provisional Patent Application Ser. No. 61/080,022 entitled “Mining Web Modalities, for Online Marketing and Content Ranking” and filed on Jul. 11, 2008, which is hereby incorporated by reference as though set forth herein in its entirety.

### FIELD OF INVENTION

The present invention relates to the determination of consumer preferences for use in marketing and advertising and more particularly to the ranking and categorization of journaled internet-media preferences for use in advertising.

### BACKGROUND OF THE INVENTION

Marketers and advertisers are often concerned with determining the best placement for an advertisement within a media stream and inserting the advertisement accordingly for greatest exposure, impact, and influence. The best placement typically corresponds to inserting an advertisement in the particular media stream most likely to be viewed by the largest audience possible that is interested in the subject or content of the advertisement.

Much research is conducted investigating audience preferences and interests to ensure the best placement of advertisements. Companies such as Nielsen BuzzMetrics attempt to gauge the audience size of television shows. Other companies use data mining to find correlations between various product and service purchases. For example, if a consumer purchases product A, data mining is used to test whether that consumer is more or less likely to purchase product B. Advertisers also examine the content of the medium (e.g., the subject of a television show or radio program) to identify products or services that are related to the content of the medium, or that have been found to be of interest to the audience of the content. For example, brokerage firms may purchase advertising time during a television show concerning stock market news. Advertisers are continually searching for new data to examine and mine to determine correlative interests of consumers of various media content.

The communities that form and gather on the Internet can be a source of data for advertisement profiling. These communities typically form around a common interest, such as a television show, support of a politician, or use of a particular consumer product. Community opinions are expressed by postings to message boards and web logs (i.e., “blogs”).

Message boards and blogs can be considered to be journaled internet data due to the way in which they are updated by the community. Message boards allow anyone in the community to start a new conversation topic, post a message to a conversation topic, or respond to another post. A blog is generally operated and maintained by a single person or a small group of people, who post information to be added to the blog. The readers of the blog can also comment on the post through an interface similar to a message board. Frequently, blog posts reference other blog posts. The popularity or influence of a blog is often judged based on the number of other blogs or internet postings that reference (e.g., hyperlink) to the blog. Additionally, the quantity and tone of the follow-up comments to the blog provide another indication of the popularity and response to a blog posting.

Unfortunately, the egalitarian nature of the internet makes it difficult to discern reliable information from journaled internet data. For example, the subject matter of a blog that is read by only a handful of people may superficially appear to be less important to an advertiser than the subject matter of a blog having thousands of readers. However, if the subject matter of the less widely read blog is also discussed on many other blogs, the less widely read blog may be of greater interest to a particular advertiser.

Accordingly, there is a need for a way to analyze the content of journaled internet data sources and measure the reliability and importance of the data source to advertisers and preferably to also quantify and measure interactions with journaled internet data sources for use in targeted advertisements and media.

### SUMMARY OF THE INVENTION

In accordance with one aspect of the present invention, a method for ranking and categorizing journaled internet data sources (e.g., message boards and blogs) for use in marketing is provided. Journaled internet data sources are identified and journal data is retrieved from one or more of the identified data sources. A classification algorithm that uses keywords, learning models such as Support Vector Machine and Naïve base may be used to classify particular retrieved journaled data. A voting algorithm then uses a combination of those classifiers to select the best fit classification to a certain journaled internet data, which can then be associated with one or more content categories of a monitoring taxonomy that specifies content categories and relationships between the content categories. The classification of the particular journaled data is analyzed and compared to other journaled internet data sources to compute an interest level indicator, an interaction level indicator, a direction level indicator, or an authority level indicator. The computed interest level indicator, direction level indicator, or authority level indicator is used to determine a ranking of the particular journaled internet data. The rankings of the particular journaled internet data are stored in a computer readable medium and provided for use in marketing profiles.

In a further aspect of the present invention, the rankings of the particular journaled internet data can be visualized with respect to a content category over a specified date range. The data can be presented as a graph (e.g., a bar chart or line graph) or in table form to illustrate the change in interest level, direction level or authority level of a content category or data source over a period of time. Additionally, the rankings can be used to perform a comparative analysis of the content categories relative to one another.

### BRIEF DESCRIPTION OF THE FIGURE

The foregoing and other features of the present invention will be more readily apparent from the following detailed description and drawings of illustrative embodiments of the invention in which the FIGURE depicts a flow diagram of a process for categorizing journaled internet data and determining content category rankings in accordance with the present invention.

### DETAILED DESCRIPTION OF PREFERRED EMBODIMENTS

By way of overview and introduction, the present invention enables advertisers to gather data from journaled internet data sources, such as blogs and message boards, concerning the content of the data sources (e.g., the community interest in the content, the increase or decrease in the interest, and the authority of the data source). A number of blogs may be analyzed to categorize the content (e.g., through the use of different classifiers). An interest level can also be calculated for the content. A content-category that is more frequently discussed relative to other content categories would be considered to have a higher interest level. Furthermore, an interaction level is represented by the number of comments or interaction with the journaled internet data. Additionally, the interest level of a given content category can be monitored over time to determine its direction level, i.e., whether the content-category is generating increasing or decreasing interest, to provide an indication of interest or sentiment in the content category. The journaled internet data sources can also be ranked based on the interest level, interaction level, direction level, and authority level as described in U.S. Provisional Patent Application Ser. No. 61/080,022, which is hereby incorporated by reference as though set forth in its entirety. Thus, interest and trends in particular content-categories can be correlated to one another for cross-marketing products. The rankings and correlations can then be used for better targeting of advertisements. For instance, now, we may know that this week, of the males of the age group 18-24 living in New York, 40% are interested in sports, 30% are interested in relationships and 30% are interested in job hunting. In a subsequent week, the same group of persons would be interested in sports, relationships, and politics with different percentages. The rankings and correlations allow the advertisers to follow the topics that interest a certain demographic.

In a further aspect of the present invention, data concerning consumer consumption of online entertainment-media (e.g., online video, online audio) can be gathered based on user interactions with those media and processed as an interaction level of the journaled internet data sources to determine content category rankings for use in targeted advertising. For example, any electronic user interaction (e.g., online TV channel changing, viewing time, and playback controls such as pause, rewind, fast-forward, etc.) can be gathered and processed this way. These interactions can be analyzed in combination with a classification of the program being viewed to further enhance content rankings. By combining the content ranking of media consumption and the rankings of journaled internet data, more comprehensive and accurate data can be provided for use in targeting advertisements.

The FIGURE illustrates a flow diagram of a process 100 for categorizing journaled internet data sources and determining content category rankings in accordance with an embodiment the present invention. Process 100 is described below with reference to journaled internet data sources such as blogs and message boards. However, it should be understood by one of ordinary skill in the art, that the process 100 can be applied to other journaled internet data sources.

At step 110, journaled internet data sources are identified. A web crawler can be used to identify the data sources. A web crawler examines pages and can identify hyperlinks. The hyperlinks may identify potential data sources. The content on each searched web page may include journaled data entries. The content can be retrieved and stored. Similarly, the hyperlinks (i.e., potential data sources) can be queued for later examination. Multiple web crawlers can be used concurrently on multiple computers or a single computer to increase the rate at which web sites are examined. Optionally, a specialized crawler, such as an ATOM/RSS feed crawler for blogs, can be used to identify and examine data sources and content.

The web crawler can be used to retrieve journaled data at step 115. Alternatively, Uniform Resource Locators (“URLs”) (e.g., hyperlinks) associated with journaled data entries can be stored and retrieved later by another software process, such as an archival tool or managed File Transfer Protocol (“FTP”) software (e.g., mget). The journaled data can be stored for later processing or analyzed as it is retrieved.

At step 120, the content of the retrieved journaled data is analyzed and classified. The classification can be accomplished using a natural keyword analysis to determine the content and tone (e.g., positive or negative) of the data. Additionally, metadata can be used for classification. If the journaled data includes multimedia, such as audio, video, or images, metadata embedded in the files (e.g., tags) can be examined for keywords and classifiable data.

The classification associates the journaled internet data (e.g., blog entry) with one or more content-categories that are specified in a monitoring taxonomy. The journaled internet data source (i.e., blog) can then be classified based on the classifications of the journaled data entries. The monitoring taxonomy also identifies relationships between content-categories. For example, two or more content categories may be highly related such that a data entry classified in one category is likely to be classified in a second category as well. The taxonomy can also indicate the strength of the relationship (e.g., how frequently the relationship occurs and how many times the relationship has been encountered).

The classification process can provide feedback for enhancing the monitoring taxonomy. At step 122, the classification of a particular journaled data entry can be analyzed to determine clusters or relationships evidenced in the particular data entry. This information can be used at step 124 to enhance the monitoring taxonomy. New relationships can be identified and reflected in the taxonomy, and existing relationships can be strengthened. Relationships that have become stale (i.e., have not been encountered over a period of time) can be removed or updated to indicate a weakening of the relationship. Optionally, the journaled data entry can be re-classified at step 120 based on the updated monitoring taxonomy.

Using the classification of the journaled data entry and the monitoring taxonomy, a number of metrics concerning the journaled data entry can be computed. For example, an interest level can be determined at step 130. The interest level can include a measure of popularity and a density of the content. The popularity is based on the number of data entries having one or more common classifications relative to the number of data entries scanned. That is, the popularity measure can include the percentage of data entries having a similar classification. The density of a data entry is based on the confidence of the classification for that data entry (e.g., the total number of times a keyword is mentioned relative to the number of the scanned data entries that mention the keyword).

A direction level can also be computed for each journaled data entry at step 140. The direction level includes an indication of the trend in the interest of a particular data entry relative to a period of time. In one example of computing the direction level, a BM25 function is used to sort the retrieved data as either positive or negative based on a predetermined set of keywords. BM25 (sometimes referred to as Okapi BM25) is a ranking function commonly used by search engines to rank matching documents according to their relevance to a given search query based on a probabilistic retrieval framework. Variants of the BM25 algorithm (e.g. BM25F, a version of BM25 that analyzes document structure and anchor text) can also be used to sort the retrieved data.

Additionally, a Naïve Keyword algorithm can be used to count the number of positive or negative keywords that are related to a certain category as specified in the taxonomy and that are within a relevant position of each sentence of the journaled data entry. A weighted keyword algorithm gives different weights to each keyword and can also be used to determine the direction level, wherein each keyword is weighted based on the meaning of the word. For example, “good” is weighted less than “excellent.” Furthermore, a support vector machine (SVM), can be used for classifying the content. The SVM is a set of related supervised learning methods used for classification and regression is another method of classifying content. In a further feature, the direction level can be computed in several different ways, and a voting algorithm that combines the results of the BM25, the Naïve Keyword, the weighted keyword and the SVM algorithms can be used to select the direction level.

A further metric concerning the authority of the journaled data entry can be computed at step 150. The authority of the data entry includes a computation of the eigenvalues for the number of relevant links to a particular data entry, the number of links from the data entry, the importance of the data entry (i.e., the interest in the data entry) within a specific community, or the user's interactions with the journaled data entry. User interactions can be captured by monitoring the number of views (e.g., accesses or requests) of a journaled data entry and/or the number of comments made regarding the journaled data entry.

To rank the authority of the individual posting a Journaled Internet Data, we build on top of the “EigenRumor” algorithm. EigenRumor is designed for ranking information resources provided as blogs or other cyberspace communities, in which the identities of information providers are observable. Using the EigenRumor algorithm, the hub and authority scores are calculated as attributes of agents (i.e., bloggers). By weighting these scores using the blog entries submitted by the blogger, the attractiveness of a blog entity that does not yet have any in-link submitted by the blogger can be estimated. The EigenRumor algorithm is useful for ranking journaled internet data entries as well as ranking the author of a journaled internet data entry.

We may use the provisioning matrix P=[pᵢⱼ] (i=1 . . . m, j=1 . . . n) to represent all provisioning links in the universe. In this notation, pᵢⱼ=1 if agent i provides object j and zero otherwise. We will use the evaluation matrix E=[eᵢⱼ] (i=1 . . . m, j=1 . . . n) to represent all evaluation links in the universe. We assume eᵢⱼ has the range of [0,1]. We define a, an “authority score,” as a vector that contains the authority scores aᵢ for agent i (i=1 . . . m). This indicates to what level agent i provided objects in the past that followed the community direction. We define h, a “hub score,” as a vector that contains the hub scores hᵢ for agent i (i=1 . . . m). This indicates to what level agent i submitted comments (evaluation) that followed the community direction on other past objects. We define r, a “reputation score,” as a vector that contains the reputation score rⱼ (j=1 n) for object j. This indicates the level of support object j received from the agents. The EigenRumor algorithm calculates three vectors, i.e., authority vector a, hub vector h, and reputation vector r. The algorithm introduces four equations as follows:

r=P^{T}a (1)

r=E^{T}h (2)

a=Pr (3)

h=Er (4)

In order to merge equation (1) and (2) above, we use the following convex combination:

r=αP^{T}a+(1−α)E^{T}h (5),

where α is a constant with range of [0,1] that controls the weight of authority score and hub score. It is adjusted depending on the target community or application. Note that a can be assigned to each object separately and can be designed to decrease with time from the submission or the number of evaluations submitted to object j. We now have three equations, (3), (4), and (5), that recursively define three score vectors, a, h, and r. To find the “equilibrium” values for the score vectors, we integrate equation. (3) and equation (4) with equation (5), and get:

$$\begin{matrix}r = α {P}^{T} Pr + ( 1 - α ) {E}^{T} Er \\ = Sr ,\end{matrix}$$

$$where S = ( α {P}^{T} P + ( 1 - α ) {E}^{T} E )$$

We can also get all of these scores simultaneously by the procedure shown below.

a⁽⁰⁾=(1 . . . 1)^{T}αα

h⁽⁰⁾=(1 . . . 1)^{T}

while r changes significantly do

r^{(k)}=αP^{T}a^{(k)}+(1−α)E^{T}h^{(k)}

r^{(k+1)}=r^{(k)}/∥r^{(k)}∥₂

a^{(k)}=Pr^{(k+1)}

h^{(k)}=Er^{(k+1)}

end while

∥.∥₂ is the function to compute the L₂ vector norm.

Tuning of the EigenRumor Algorithm:

We need to consider the effect of user interaction on ranking blogs. We define a user interaction matrix U whose elements uᵢⱼ indicate how many times a user (agent) has accessed a post (object).

U=[uᵢⱼ] (i=1 . . . m, j=1 . . . n), uᵢⱼ=0 or a positive integer,

wherein uᵢⱼ is zero when the user accesses his own written post, and uᵢⱼ is a positive integer otherwise. This contributes to the reputation score of the objects.

r=U^{T}a

Merging all the equations,

$$\begin{matrix}r = α {P}^{T} a + β {E}^{T} h + ( 1 - α - β ) {U}^{T} a \\ = Sr ,\end{matrix}$$

$$where S = α {P}^{T} P + β {E}^{T} E + ( 1 - α - β ) {U}^{T} P . \\ Initially , α > β and ( 1 - α - β ) > β .$$

Efficient Matrix Multiplication:

Calculation of S involves two types of matrix multiplication: transpose of a matrix multiplied by the original matrix (P^{T} P, E^{T} E) and transpose of a matrix multiplied by another matrix (U^{T} P). The first type of matrix multiplication offers potential to efficiently process the multiplication as described below.

a) A transpose matrix needed not be created, saving processing time and storage.
b) Elements of the result can be obtained from (n+ⁿC₂) scalar product terms rather than n² scalar product terms, saving processing time.
Cj is the j-th column of the transpose matrix. There are:
n—self scalar product terms, Cj.Cj
ⁿC₂—mutual scalar product terms, Cx.Cy, x≠y

The elements of the product matrix can be obtained as follows:

$$\begin{matrix}{C}_{1} \cdot {C}_{1} & {C}_{1} \cdot {C}_{2} & {C}_{1} \cdot {C}_{3} & … & {C}_{1} \cdot Cn \\ {C}_{2} \cdot {C}_{1} & {C}_{2} \cdot {C}_{2} & {C}_{2} \cdot {C}_{3} & … & {C}_{2} \cdot Cn \\ Cn \cdot {C}_{1} & Cn \cdot {C}_{2} & Cn \cdot {C}_{3} & … & Cn \cdot Cn\end{matrix}$$

For the second type of matrix multiplication, UT P, all n² scalar product terms need to be calculated and the final product matrix is obtained as follows:

$$\begin{matrix}{C}_{1 U} \cdot {C}_{1 P} & {C}_{1 U} \cdot {C}_{2 P} & {C}_{1 U} \cdot {C}_{3 P} & … & {C}_{1 U} \cdot {Cn}_{P} \\ {C}_{2 U} \cdot {C}_{1 P} & {C}_{2 U} \cdot {C}_{2 P} & {C}_{2 U} \cdot {C}_{3 P} & … & {C}_{2 U} \cdot {Cn}_{P} \\ {C}_{n U} \cdot {C}_{1 P} & {C}_{n U} \cdot {C}_{2 P} & {C}_{1 U} \cdot {C}_{n P} & … & {C}_{n U} \cdot {Cn}_{P}\end{matrix}$$

As before, transpose matrix needed not be created, saving processing time and storage.

Compact Storage and Processing Support:

As there are only a few nonzero elements in P, E, and U, we store the row and column indices of each nonzero element in two separate arrays. So, for each of the above matrices, two arrays will be used to indicate the nonzero elements. These arrays are much shorter than P, E, and U saving storage space. To support the above efficient matrix multiplication, the scalar product terms need to be created from these arrays.

To find the self scalar product terms, Cj.Cj, we need to count the number of entries for that column in the column-array. This count is the value of Cj.Cj.

To find the mutual scalar product terms, Cx.Cy, x≠y, we check the column array for x. If found, we read the corresponding row entry (Rm) from the row-array. Then we check the column array for y. If found, we check the corresponding row entry from the row-array for Rm. If there is a match, the scalar product term is incremented by 1. This process is repeated for all the entries of x in the column-array. The author of each post is ranked based on the above algorithm as a part of ranking the importance of the author of each post and, accordingly, the importance of his journaled internet entry.

Each journaled data entry can be ranked at step 160 based on any of the computed metrics or a weighted score of a combination of metrics. The weights used for ranking can be altered to model various user profiles. For example, a particular user profile may highly value the direction (i.e., trend) level of content, but not overall interest in the content. This particular user profile would weigh the direction level more heavily than the interest level. The computed metrics can also be aggregated and sorted based on an industry category identified in the monitoring taxonomy. Thus, at step 170 a comparative analysis of the data entries can be performed to determine trends or anomalies within an industry.

The ranking and metrics computed in the foregoing process 100 may be stored in a computer readable medium. This information can be used to develop profiles for targeting advertisements. Once a particular category is associated with a set of blog entries, the profile of the blog authors can be considered to be representative of the potential consumers of information pertaining to the particular category. For example, if 80% of the internet bloggers writing about baby-related content are female, then 80% of the advertisements disseminated to blogs in the baby content category can be targeted to females. As the distribution of representative blog authors may vary each day, the advertisement distribution varies accordingly.

The ranking and metrics computed in the foregoing process 100 can be visualized in various ways. For example, the information may be integrated into a business intelligence report. Further, if a user desires to receive a graphical representation of the data at step 180, at step 182, the user can specify a category or content-type and optionally a date range of interest. At step 184, a line chart or a bar chart is generated to illustrate the specified content-type rankings over the specified period of time.

The analysis of journaled internet data sources and data entries, as described above, provides meaningful and systematic metrics that can be considered in business analysis and marketing efforts. This data can be further enhanced by combining it with other known metrics of consumer preferences, for example, by combining the information derived from journaled internet data sources with consumer entertainment consumption habits (e.g., television viewing habits).

While the invention has been described in connection with certain embodiments thereof, the invention is not limited to the described embodiments but it will be understood by those of ordinary skill in the art that that various changes in form and details may be made therein without departing from the spirit and scope of the invention.

We claim:

1. A method for ranking and categorizing journaled internet data sources, comprising the steps of:
identifying, with at least one web crawler operating on a computer, a plurality of journaled internet data sources;
retrieving journaled internet data entries from at least a subset of the plurality of journaled internet data sources;
applying a voting algorithm between multiple classification algorithms that are keyword dependent and machine learning dependent to classify a particular journaled internet data entry selected from the journaled internet data entries;
associating the particular journaled internet data entry with one or more content categories of a monitoring taxonomy, the monitoring taxonomy specifying a plurality of content categories and a plurality of relationships between the plurality of content categories;
computing at least one of an interest level, an interaction level, a direction level, and an authority level for the particular journaled internet data entry; and
ranking the particular journaled internet data entry based on the at least one of the interest level, the direction level, the interaction level and the authority level.

2. The method of claim 1 wherein the voting algorithm is configured to identify relationships in the monitoring taxonomy, the method further comprising the step of enhancing the monitoring taxonomy based on the relationships identified by the voting algorithm.

3. The method of claim 1 wherein the journaled internet data entries comprise blog entries.

4. The method of claim 1 wherein the plurality of journaled internet data sources includes at least one of RSS feeds and ATOM feeds.

5. The method of claim 1 wherein the step of retrieving journaled internet data entries from the at least a subset of identified journaled internet data sources comprises retrieving data using an ATOM/RSS feed crawler

6. The method of claim 1 wherein the interest level includes a measure of a popularity and a density, the popularity being based on a number of the journaled internet data entries having one or more common classifications relative to a number of the retrieved journaled internet data entries and the density being based on a number of times a keyword is mentioned in the particular journaled internet data entry relative to a number of the retrieved journaled internet data entries that mention the keyword.

7. The method of claim 1 wherein the direction level includes an indication of a trend in the interest level relative to a time period.

8. The method of claim 7 wherein the direction level is computed using a weighted keyword algorithm.

9. The method of claim 7 wherein the direction level is computed using a naïve keyword algorithm.

10. The method of claim 7 wherein the direction level is computed using a weighted keyword algorithm, a naïve keyword algorithm, a Support Vector Machine and a BM-25 function and by applying a voting algorithm to results of the weighted keyword algorithm, the naïve keyword algorithm, a Support Vector Machine and the BM-25 function to determine the direction level.

11. The method of claim 1 wherein the authority level includes a weighted score of at least the interest level and the direction level.

12. The method of claim 1 wherein the step of computing the authority level uses a content ranking algorithm that utilizes at least one of a number of links to the particular journaled internet data entry, a number of links from the particular journaled internet data entry, a measure of importance of the particular journaled internet data entry, and a user's interaction with the particular journaled internet data entry.

13. The method of claim 12 wherein the content ranking algorithm ranks the particular journaled internet data entry using eigenvalues from the number of links to the particular journaled internet data entry, the number of links from the particular journaled internet data entry, the measure of importance of the particular journaled internet data entry, and the user's interaction with the particular journaled internet data entry.

14. The method of claim 12 wherein the content ranking algorithm utilizes a method for sparse matrix calculation in order to conserve storage space and to lower a number of calculations and therefore the energy consumption by the calculations

15. The method of claim 1 further comprising the steps of:
receiving a selection of a content type;
determining a desired date range; and
visualizing for the selected content type over the desired date range the at least one of the interest level, the direction level, and the authority level.

16. The method of claim 1 wherein the content categories of the monitoring taxonomy include at least one industry category, the method further comprising the steps of:
selecting a plurality of rankings for the at least one industry category; and
analyzing the selected rankings for at least one of an industry trend, an inter-industry similarity, and an industry anomaly.

17. The method of claim 1, further comprising the step of providing the ranking of the particular journaled internet data entry for use in marketing.

18. A method for ranking and categorizing internet blogs for use in marketing, comprising the steps of:
identifying a plurality of blogs using a web crawler operating on a computer, each blog having a plurality of blog entries;
retrieving one or more blog entries from at least a subset of the identified plurality of blogs;
applying a voting algorithm to classify a particular blog entry, selected from the one or more blog entries;
associating the particular blog entry with one or more content categories of a monitoring taxonomy, wherein the monitoring taxonomy specifies a plurality of content categories and a plurality of relationships between the plurality of content categories;
computing for the particular blog entry an interest level including a popularity based on a number of blog entries having one or more common classifications relative to a number of the retrieved blog entries, and a density based on a number of times a keyword is mention in the particular blog entry relative to a number of the retrieved blog entries that mention the keyword;
computing for the particular blog entry a direction level, the direction level being an indication of a trend in the interest level relative to a time period,
computing for the particular blog entry an authority level, the authority level being computed using a content ranking algorithm including as inputs a number of links to the particular blog entry, a number of links from the particular blog entry, a measure of importance of the particular blog entry, and a user's interaction with the particular blog entry;
ranking the blog entry based on the computed interest level, the direction level, and the authority level; and
providing the blog entry ranking for use in directed marketing.
